(19) United States
(12) Patent Application Publication
(10) Pub. No.: US 2005/0030571 A1
(43) Pub. Date: Feb. 10, 2005

(54) Printer apparatus, image forming apparatus and program of printer apparatus

(75) Inventors: Yuusuke Suzuki, Mishima-shi (JP); Takahiro Hagiwara, Chiba-shi (JP); Akira Saito, Tokyo (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/892,488

(22) Filed: Jul. 16, 2004

(30) Foreign Application Priority Data
Jul. 17, 2003 (JP) 2003-198543

(51) Int. Cl. G06F 15/00

(52) U.S. Cl. 358/1.13

(57) ABSTRACT

A printer apparatus which performs image formation by using given PDL information, including a generating unit which generates background image information and black image information drawn by black pixels from the PDL information, an erasing unit which erases a part of image information superimposed on an area of the black image information from the background image information in accordance with a particular pattern, and a forming unit which performs the image formation on the basis of the background image information and the black image information which are partially erased.

### CROSS-REFERENCE TO RELATED APPLICATIONS

This application is based upon and claims the benefit of priority from the prior Japanese Patent Application No. 2003-198543, filed Jul. 17, 2003, the entire contents of which are incorporated herein by reference.

### BACKGROUND OF THE INVENTION

1. Field of the Invention

The present invention relates to a printer apparatus, an image forming apparatus, and a program of the printer apparatus which use a black over print technique.

2. Description of the Related Art

Recently, as performance of the image forming apparatus such as a digital copying machine is improved, integrated digital equipment which has not only a copying function but also a function as the printer has been developed, and the integrated digital equipment is becoming widespread. In the image forming apparatus such as the integrated digital equipment, while the extremely high-quality image is formed, additional functions properly satisfying various demands are required.

In Patent Document (U.S. Pat. No. 5,923,821, David Birnbaum et al., dated Jul. 13, 1999), examples of a trapping technique (a method of printing a boundary portion of colors such that colors are superimposed on each other) and a black over print technique (a method of printing black while black is overlapped with other colors) are well known as a method of preventing a white patch on a printed image caused by print shift of black characters, black lines, or the like. Namely, in a color printer which performs color printing by superimposing CMYK (Cyan, Magenta, Yellow, and Black) four colors of toner on one another, sometimes the slight shift occurs in a printing position of each color. In the case where the black character or the black line is printed on the background in a dense color, when the print shift occurs, a part where the toner is absent is formed and the printed matter becomes unsightly. Therefore, the techniques such as the black over print are used as measures against the print shift. However, when the techniques such as the black over print are simply adopted for a print medium, the amount of toner which can be fixed onto a recording medium exceeds a limit value, and toner peeling or toner adhesion around a drum is generated, so that the amount of toner is suppressed by the method of skipping one color in the four colors from image information of the background colors in U.S. Pat. No. 5,923,821.

However, in the above-described prior art, when one color such as magenta is skipped in the image information of the background image, the color of the background image is obviously changed. Therefore, when the print shift is generated, there is a problem that color change of the background image becomes obtrusive and the high-quality print can not be obtained.

### BRIEF SUMMARY OF THE INVENTION

An embodiment of the invention is a printer apparatus which forms an image on the basis of given PDL information, comprising a generating unit which generates background image information and black image information drawn by black pixels from the PDL information, an erasing unit which erases a part of image information superimposed on an area of the black image information from the background image information generated by the generating unit, and a forming unit which forms an image on a recording medium on the basis of the background image information and the black image information which are partially erased.

### BRIEF DESCRIPTION OF THE SEVERAL VIEWS OF THE DRAWING

FIG. 1 is a block diagram showing an example of a configuration of an image forming apparatus according to an embodiment of the invention;

FIG. 2 is a flow chart showing an example of pixel skipping processing of the image forming apparatus according to the embodiment of the invention;

FIG. 3 shows an example of background image information to which the image forming apparatus according to the embodiment of the invention attempts to perform the pixel skipping processing;

FIG. 4 shows an example of a black object in accordance with the background image information to which the image forming apparatus according to the embodiment of the invention attempts to perform the pixel skipping processing;

FIG. 5 shows an example of the background image information when the image forming apparatus according to the embodiment of the invention erases a normal background image;

FIG. 6 shows an example of the background image information after the image forming apparatus according to the embodiment of the invention erases the normal background image;

FIG. 7 shows an example of a pixel skipping pattern unique to the invention which is performed by the image forming apparatus according to the embodiment of the invention;

FIG. 8 shows another example of the pixel skipping pattern unique to the invention which is performed by the image forming apparatus according to the embodiment of the invention;

FIG. 9 shows another example of the pixel skipping pattern unique to the invention which is performed by the image forming apparatus according to the embodiment of the invention;

FIG. 10 shows another example of the pixel skipping pattern unique to the invention which is performed by the image forming apparatus according to the embodiment of the invention;

FIG. 11 shows another example of the pixel skipping pattern unique to the invention which is performed by the image forming apparatus according to the embodiment of the invention;

FIG. 12 shows another example of the pixel skipping pattern unique to the invention which is performed by the image forming apparatus according to the embodiment of the invention;

FIG. 13 shows an example of the background image information to which the image forming apparatus according to the embodiment of the invention performs the pixel skipping processing;

FIG. 14 shows an example of the black object in accordance with the background image information to which the image forming apparatus according to the embodiment of the invention performs the pixel skipping processing;

FIG. 15 shows an example of the background image information after the image forming apparatus according to the embodiment of the invention performs the pixel skipping processing with the pixel skipping pattern unique to the invention;

FIG. 16 shows an example of background image information when the image forming apparatus according to the embodiment of the invention forms a black image by performing the pixel skipping processing with the pixel skipping pattern unique to the invention;

FIG. 17 is an explanatory view showing a specific example of processing when the image forming apparatus according to the embodiment of the invention expands a subject of black over print not only to the 100% black object but also to the 100% black object having a white component;

FIG. 18 shows the pixel skipping patterns in accordance with a type of print medium, a type of half tone screen, and a type of drawing object, which are performed by the image forming apparatus according to the embodiment of the invention; and

FIG. 19 shows the pixel skipping patterns in accordance with a type of color transformation, printing direction, and decision result of a 100% black object size, which are performed by the image forming apparatus according to the embodiment of the invention.

### DETAILED DESCRIPTION OF THE INVENTION

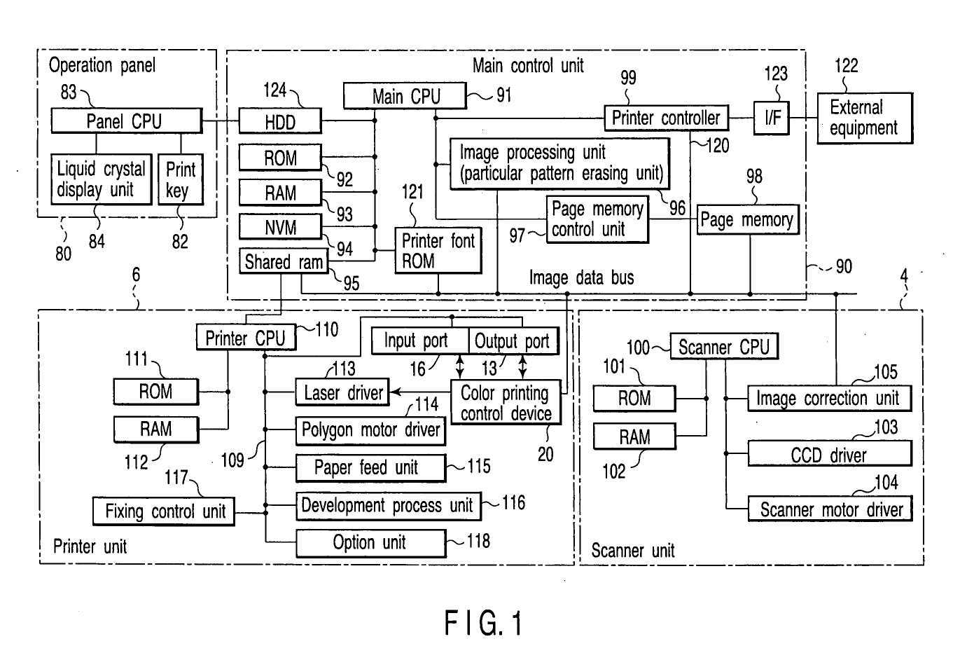

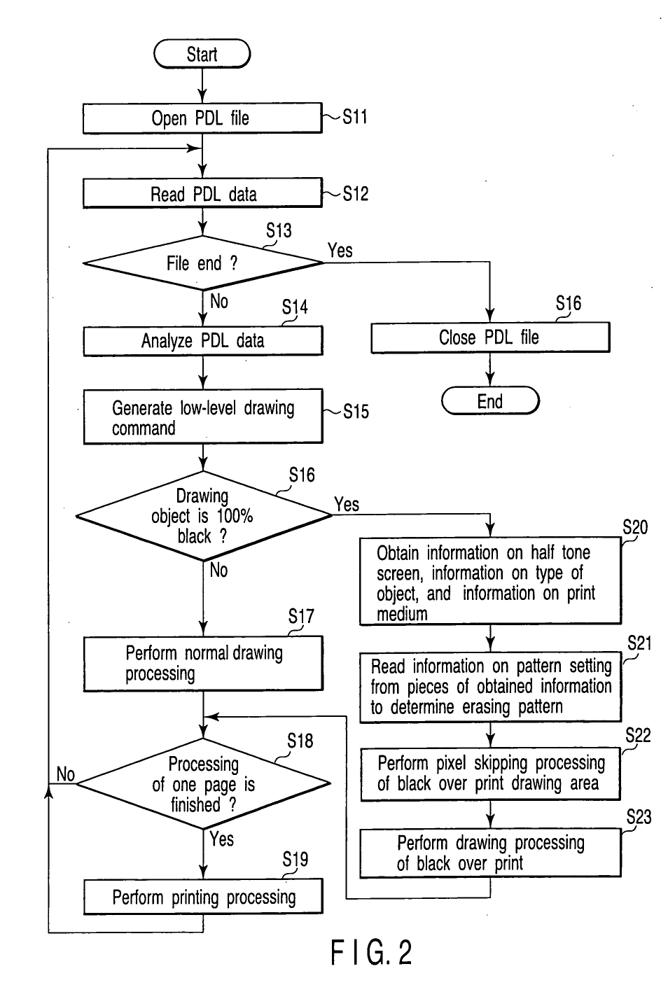

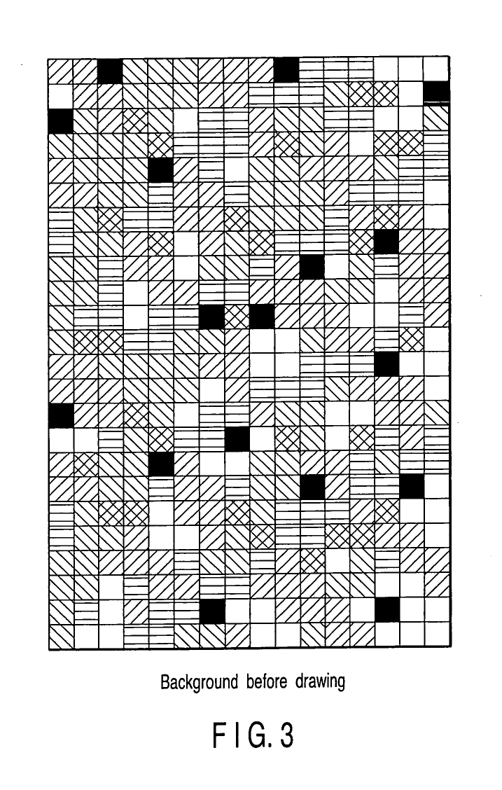

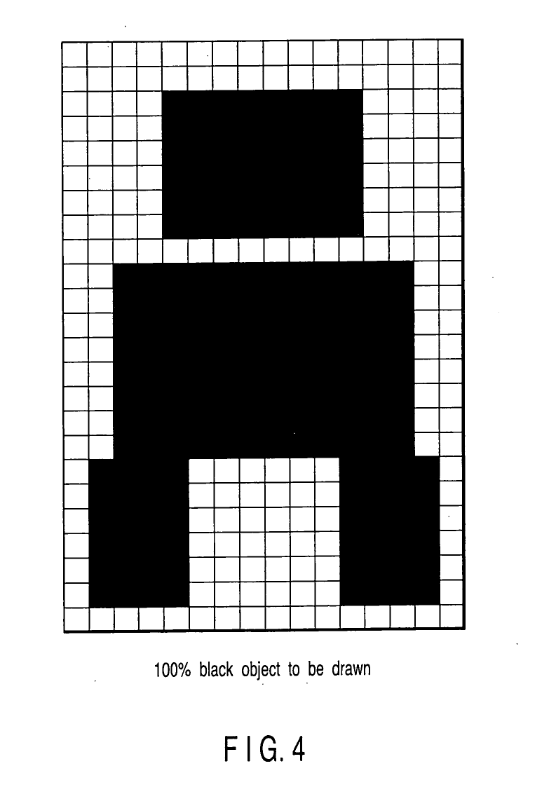

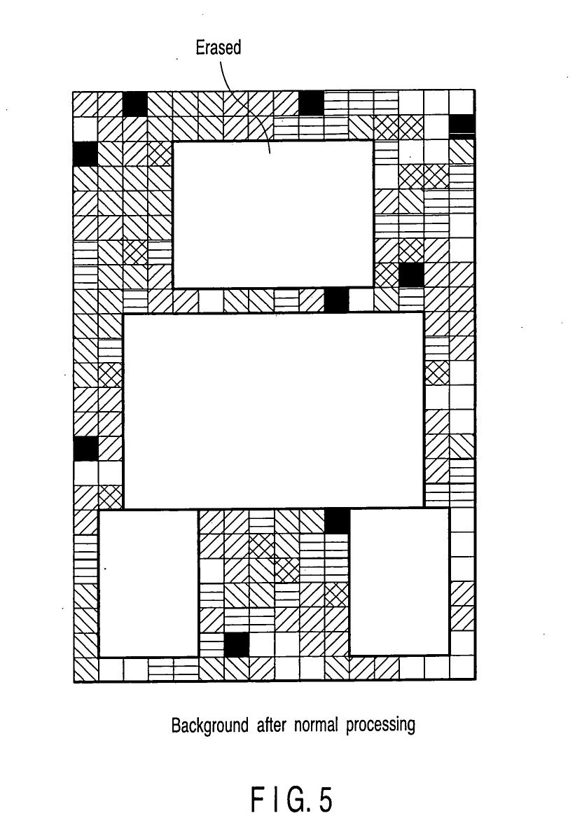

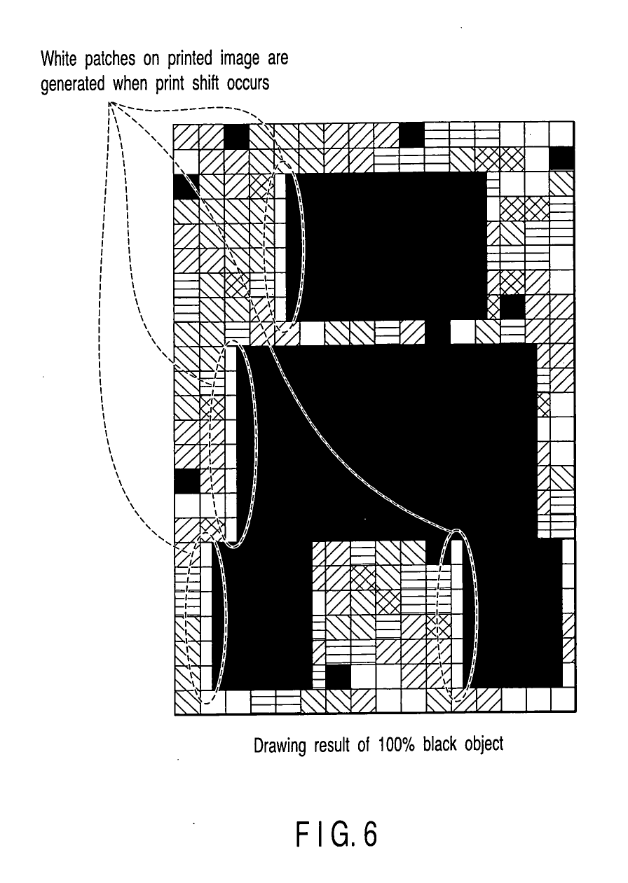

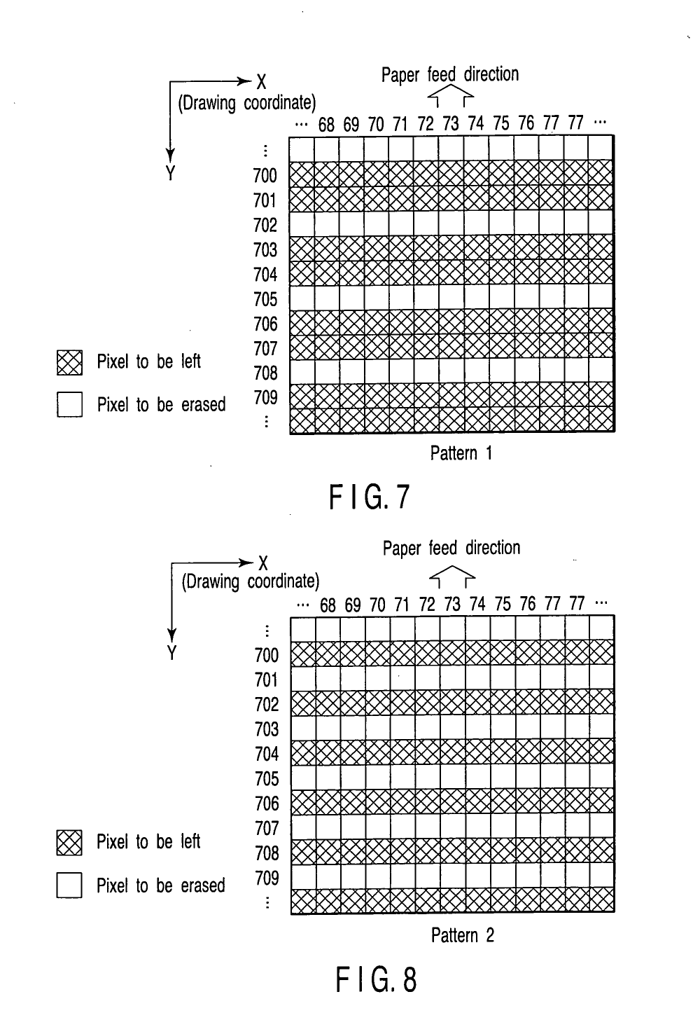

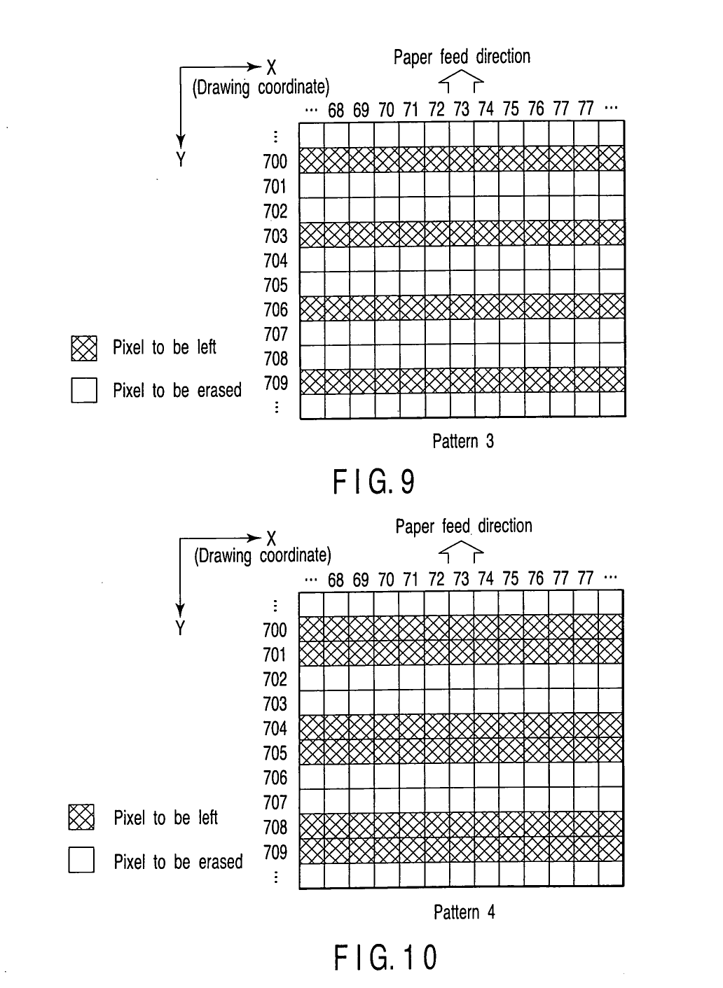

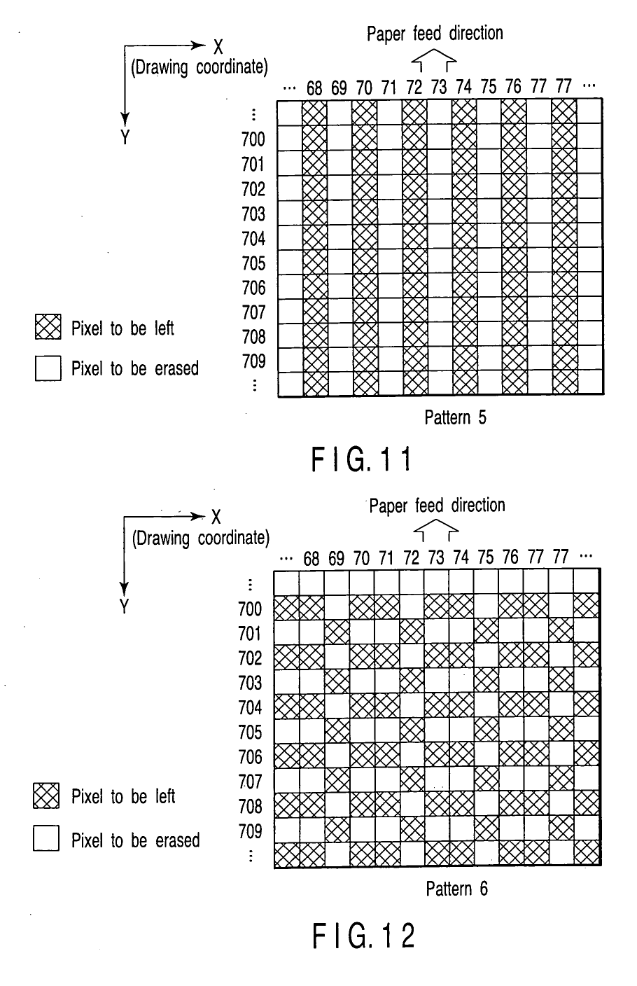

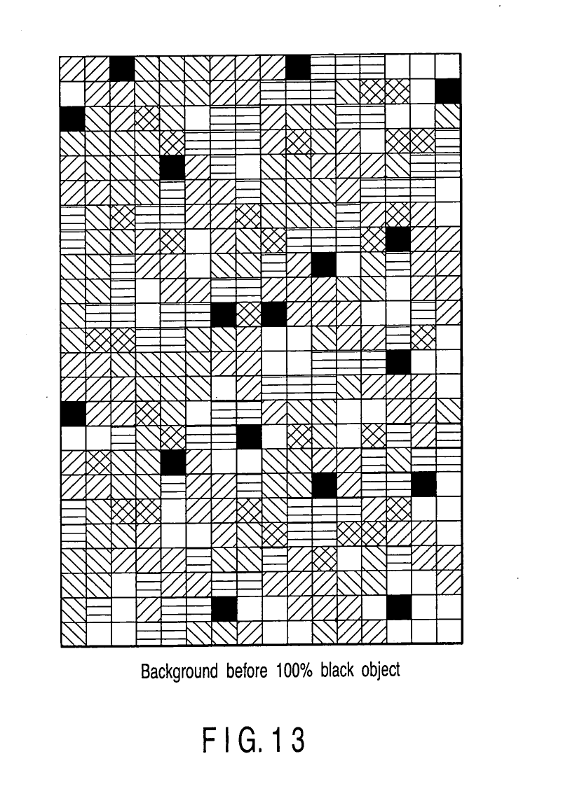

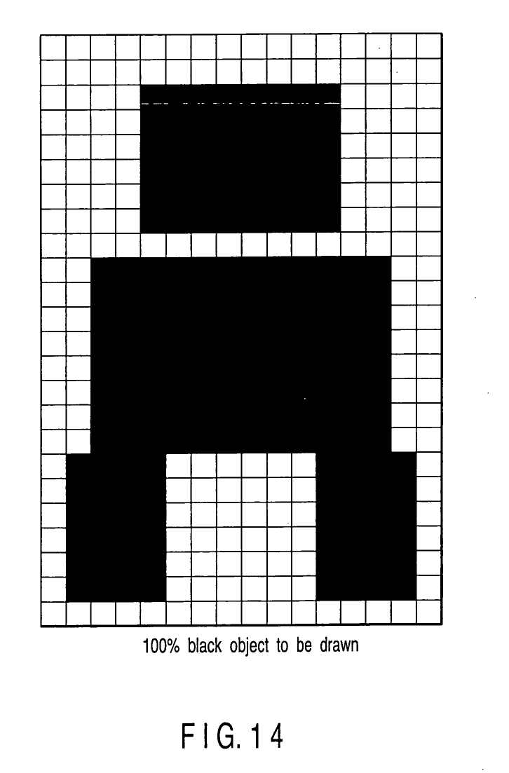

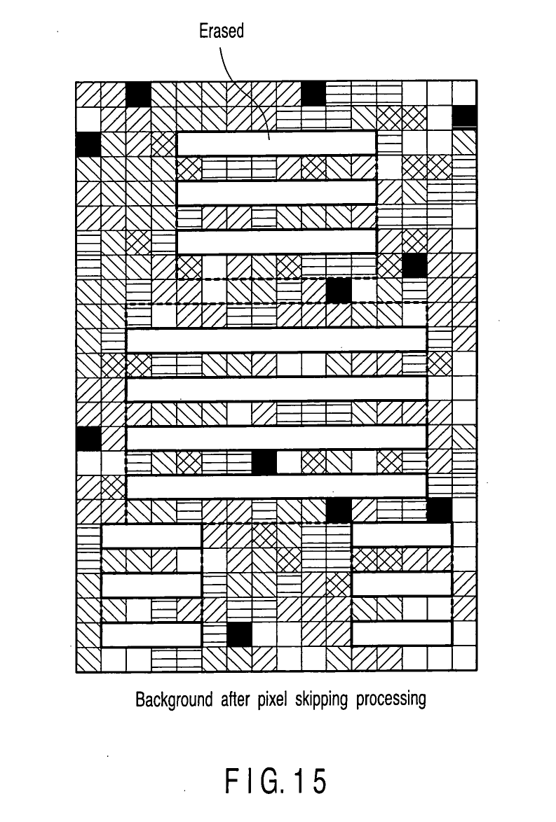

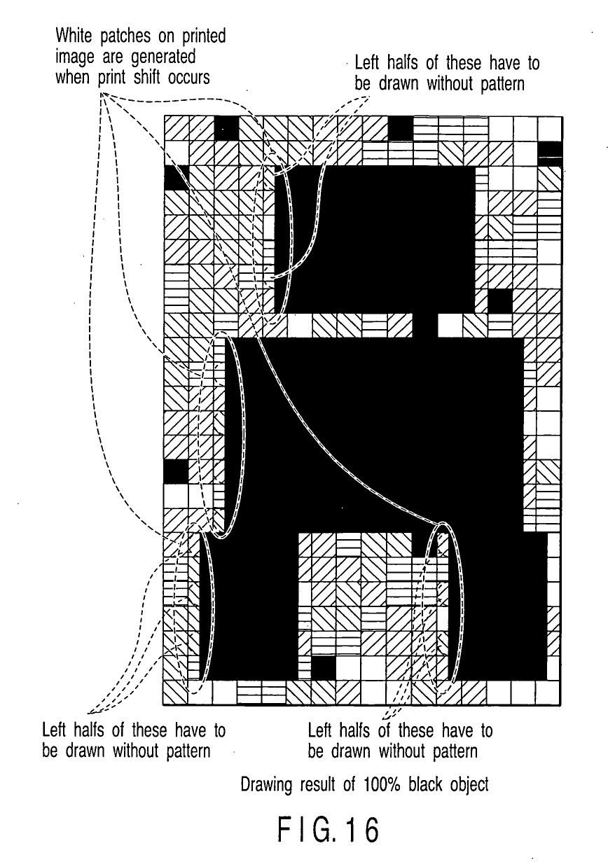

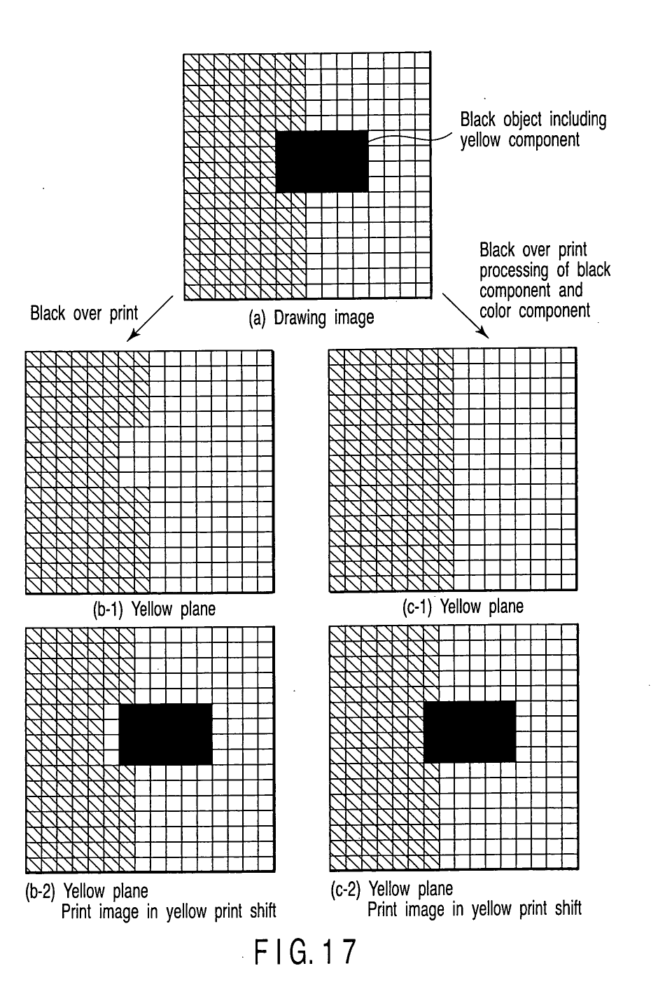

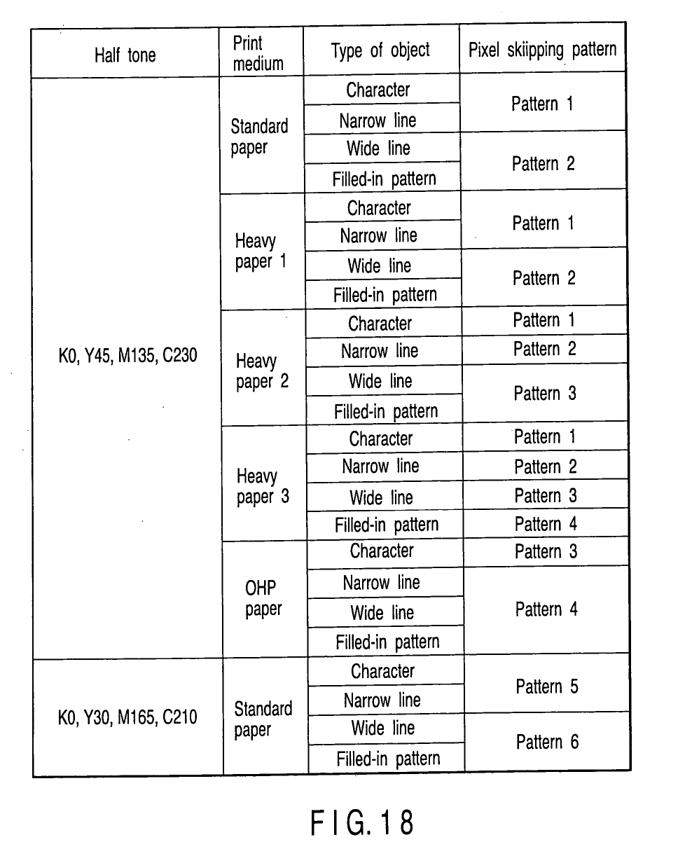

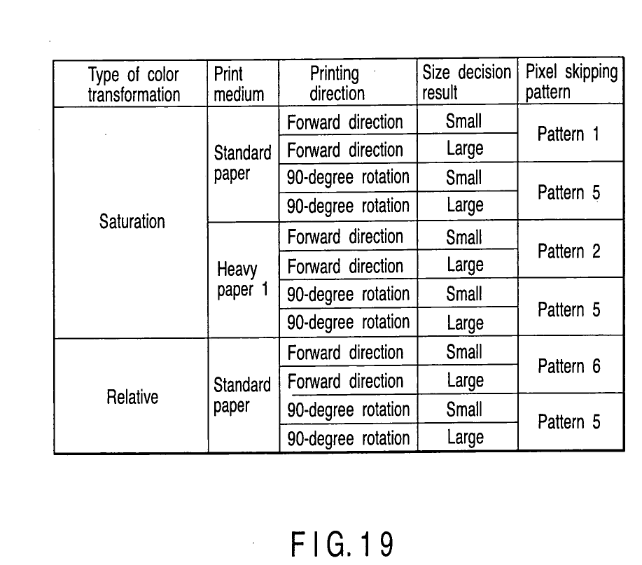

The image forming apparatus according to an embodiment of the invention will be described in detail referring to the accompanying drawings. FIG. 1 is a block diagram showing an example of a configuration of an image forming apparatus according to an embodiment of the invention, FIG. 2 is a flow chart showing an example of pixel skipping processing of the image forming apparatus, FIG. 3 shows an example of background image information to which the image forming apparatus attempts to perform the pixel skipping processing, FIG. 4 shows an example of a black object in accordance with the background image information to which the image forming apparatus performs the pixel skipping processing, FIG. 5 shows an example of background image information when the image forming apparatus erases a normal background image, FIG. 6 shows an example of the background image information after the image forming apparatus erases the normal background image, FIG. 7 shows an example of a pixel skipping pattern unique to the invention which is performed by the image forming apparatus, FIG. 8 shows another example of the pixel skipping pattern unique to the invention, FIG. 9 shows another example of the pixel skipping pattern unique to the invention, FIG. 10 shows another example of the pixel skipping pattern unique to the invention, FIG. 11 shows another example of the pixel skipping pattern unique to the invention, FIG. 12 shows another example of the pixel skipping pattern unique to the invention, FIG. 13 shows an example of the background image information to which the image forming apparatus attempts to perform the pixel skipping processing, FIG. 14 shows an example of the black object in accordance with the background image information in which the image forming apparatus attempts to perform the pixel skipping processing, FIG. 15 shows an example of the background image information after the image forming apparatus performs the pixel skipping processing with the pixel skipping pattern unique to the invention, FIG. 16 shows an example of the background image information when the image forming apparatus forms a black image by performing the pixel skipping processing with the pixel skipping pattern unique to the invention, FIG. 17 is an explanatory view showing a specific example of processing when the image forming apparatus expands a subject of the black over print not only to the 100% black object but also to the 100% black object having a white component, FIG. 18 shows the pixel skipping patterns in accordance with a type of print medium, a type of half tone screen, and a type of drawing object, which are performed by the image forming apparatus, and FIG. 19 shows the pixel skipping patterns in accordance with a type of color transformation, printing direction, and decision result of a 100% black object size, which are performed by the image forming apparatus.

(Configuration of Image Forming Apparatus)

In the block diagram shown in FIG. 1, the digital copying machine which is the image forming apparatus according to the invention includes three CPUs (Central Processing Unit), i.e. a main CPU 91 in a main control unit 90, a scanner CPU 100 in a color scanner unit 4, and a printer CPU 110 in a color printer unit 6. The main CPU 91 bilaterally communicates with the printer CPU 110 through a shared RAM 95. The main CPU 91 provides an operating direction and the printer CPU 110 sends back an operating status to the main CPU 91. The printer CPU 110 and the scanner CPU 100 perform serial communication. The printer CPU 110 provides the operating direction and the scanner CPU 100 sends back an operating status to the printer CPU 110.

An operation panel 80 is connected to the main CPU 91. The main control 90 includes the main CPU 91, a ROM 92, a RAM 93, an NVM 94, the shared RAM 95, an image processing unit (generating unit and erasing unit) 96, a page memory control unit 97, a page memory 98, a printer controller 99, a printer font ROM 121, an interface (I/F) 123, and an HDD 124.

The main CPU 91 controls the whole of the main control unit 90. A control program is stored in the ROM 92. Data is temporarily stored in the RAM 93.

The NVM (Nonvolatile RAM) 94 is a nonvolatile memory which backups a battery (not shown), and the data on the NVM 94 is retained when the power is turned off.

The shared RAM 95 is used for performing the bilateral communication between the main CPU 91 and the printer CPU 110.

The page memory control unit 97 causes the page memory 98 to store or read the image information. The page memory 98 has an area where the plurality of pages of the image data can be stored, and the data in which the image data from the scanner unit 4 is compressed is storably formed in each one page.

Font data corresponding to print data is stored in the printer font ROM 121.

The printer controller 99 expands the print data, which is inputted from external equipment 122 such as a personal computer, to the image data by using the font data stored in the printer font ROM 121 with resolution according to the data showing the resolution given to the print data through an input port 16. The external interface (I/F) 123 performs the communication of various signals with the external equipment 122.

The scanner unit 4 includes the scanner CPU 100 which controls the whole of the scanner unit 4, a ROM 101 in which the control program and the like are stored, a RAM 102 for data storage, a CCD driver 103 which drives a CCD sensor 34, a scanner motor driver 104, and an image correction unit 105. The scanner motor driver 104 controls the rotation of a motor which moves an exposure lamp 25 and mirrors 26, 30, and 31. The image correction unit 105 includes an A/D conversion circuit which converts an analog signal into a digital signal, a shading correction circuit, and a line memory. The shading correction circuit corrects variations in CCD sensors 34 or a fluctuation in threshold level to the output signal from the CCD sensor 34 which is caused by a change in ambient temperature. The line memory temporarily stores the shading-corrected digital signal from the shading correction circuit.

The printer unit 6 includes the printer CPU 110 which controls the whole of the printer unit 6, a ROM 111 in which the control program and the like are stored, a RAM 112 for data storage, a laser driver 113 which turns on and off emission (exposure) by a semiconductor laser, a polygon motor driver (motor control device) 114 which controls the rotation of a polygon motor of a laser unit, a paper feed unit 115 which controls the feed of paper through a feed path, a development process unit 116 which performs charge, development, and transfer by using an electrifying charger 45, a development unit 46, and a transfer charging device 48, a fixing control unit 117 which controls a fixing unit 60, an option unit 118, an output port 13, the input port 16, and a color printing control device 20 which is the embodiment of the invention.

The image processing unit 96, the page memory 98, the printer controller 99, the image correction unit 105, the laser driver 113, and the shared RAM 95 are connected to one another by an image data bus 120.

In the image forming apparatus (printer apparatus) having the above-described configuration, the black over print processing associated with the pixel skipping processing unique to the invention is executed as the operation of the program stored in the main CPU 91 and HDD 124 and the operation of the image processing unit 96. Alternatively, it is also preferable that the pixel skipping processing is executed by the circuit configuration of the image processing unit 96.

The invention will be described by using the digital copying machine. Alternatively, it is preferable that the invention is realized as the printer apparatus including the main control unit 90, the printer unit 6, and the operation panel 80. (Operation of Pixel Skipping Processing Which is of the Feature of the Invention) Then, an embodiment of a black over print processing associated with the pixel skipping processing which is a feature of the invention will be described by using the flow chart of FIG. 2. In the beginning, PDL (Page Description Language, Postscript Level 3, PCL-XL and the like) is generated by using the printer driver in the personal computer or the like. The PDL is transmitted to the image forming apparatus through a transmission medium such as a network and the external interface 123, and the PDL is temporarily stored as a file in the image forming apparatus. A RIP (Raster Image Processor) opens the PDL file (S11) and reads PDL data to analyze the PDL data (S14). Then, the RIP generates low-level drawing command (display list) (S15).

It is determined whether the generated low-level drawing command is an object drawn by 100% black or not (S16). When the generated low-level drawing command is the object drawn by the 100% black, drawing processing for the black over print is performed (S20 to S23). When the generated low-level drawing command is not the object drawn by the 100% black, normal processing is performed by a procedure shown in FIGS. 3 to 6 (S17).

In the normal processing, as shown in FIG. 5, a portion which is superimposed on the object drawn by the 100% black shown in FIG. 4 is erased in a background portion which has been already drawn shown in FIG. 3, and then, as shown in FIG. 6, the 100% black object is drawn to the background image information of FIG. 5. In this case, when the print shift occurs, since the white patches are generated on the printed image, the drawing result is hardly the high-quality image.

On the other hand, in accordance with the black over print processing associated with the pixel skipping processing unique to the invention, in the case of the object drawn by the 100% black, all the portions superimposed on the 100% black object are not erased, but limits in which fixing failure is not generated is judged to erase the minimum pixels (pixel skipping). Therefore, the fixing failure is not generated, and the white patches on the printed image caused by the print shift can be reduced. Further the high-quality print image can be obtained in such a manner that the plurality of pixel skipping patterns to be erased is prepared to select the optimum pattern in consideration of various conditions.

FIG. 18 shows an example of a set of pixel skipping patterns. The pixel skipping pattern is determined by determining the type of print medium, the type of half tone screen, and the type of drawing object. The table shown in FIG. 18 can be customized and changed.

When the information on the type of half tone screen, the information on the type of drawing object, the information on the print medium, and the like are obtained by the processing of the main CPU 91 or the like (S20), one pixel skipping pattern is determined from the set of pixel skipping patterns shown in FIG. 18 by the pieces of the obtained information (S21). After the pixel skipping pattern is determined, the background is thinned (erased) by the determined pixel skipping pattern (S22).

FIGS. 7 to 12 show an example of the specific pixel skipping pattern. The pattern of FIG. 7 shows reiteration of one erased line and two non-erasure lines in a direction perpendicular to a paper feed direction. The pattern of FIG. 8 shows the reiteration of one erased line and one non-erasure line in the direction perpendicular to the paper feed direction. The pattern of FIG. 9 shows the reiteration of two erased lines and one non-erasure line in the direction perpendicular to the paper feed direction. The pattern of FIG. 10 shows the reiteration of two erased lines and two non-erasure lines in the direction perpendicular to the paper feed direction. The pattern of FIG. 11 shows the reiteration of one erased line and one non-erasure line in the direction parallel to the paper feed direction. In the pattern of FIG. 12, a bit operation of the pixel skipping pattern is performed to give periodicity to the pixel skipping pattern, and the predetermined reiteration pattern of a non-erasure area and an erased area obtained by the bit operation is shown in FIG. 12.

The application examples of the patterns shown in FIGS. 7 to 12 will be described in detail below referring to FIGS. 13 to 16. FIG. 13 shows an example of the background image information to which the image forming apparatus attempts to perform the pixel skipping processing. FIG. 14 shows an example of the black object in accordance with the background image information to which the image forming apparatus attempts to perform the pixel skipping processing, and FIG. 14 also show the area where the pixel skipping processing is performed. FIG. 15 shows the result in which the pixel skipping processing has been performed by applying the pixel skipping pattern 2. FIG. 16 shows the drawing result, in which the pixel skipping processing has been properly performed.

In this case, the area where the pixel skipping processing is performed is determined not by a drawing start position of the object but by an absolute coordinate of the background. This is because disturbance of the pixel skipping pattern is generated when the erasure is performed by using the drawing start position of the object. FIG. 16 shows the result, in which the black object is drawn on the background image to which the pixel skipping processing has been performed. As can be seen from FIG. 16, a part of the background image is left on the left side of the 100% black object and the white patches on the printed image become unobtrusive. Further, the toner quantity is decreased by the pixel skipping of the background image and the fixing failure is hard to generate.

In the case of the print medium having severer conditions, the amount of pixel skipping is increased. On the contrary, in the case of the print medium having allowance, the amount of pixel skipping is decreased. In the above-described manner, the white patches on the printed image which are caused by the print shift can be prevented, and the fixing failure of the toner can be prevented at the same time.

(Example of Another Pixel Skipping Pattern)

FIG. 19 shows a decision table of the pixel skipping pattern replacing the table shown in FIG. 18. In the table shown in FIG. 19, the decision results of the type of color transformation, the printing direction, the size of the 100% black object are used as the determination factors of the pixel skipping pattern. The type of color transformation is one of factors which determine the showing of the output image, and the print image having the good quality can be obtained in such a manner that the pixel skipping pattern is change by the type of color transformation. The pixel skipping pattern determined by the printing direction is effective for measures against the case that the print shift occurs while leaning to the paper feed direction or the direction perpendicular to the paper feed direction. In performing the pixel skipping of the background, depending on the pixel skipping pattern, sometimes the pixel skipping is not performed to the small object or the open parts are increased too many and the effect of the black over print is eliminated due to the period of the pixel skipping. The above-described non-application of the pixel skipping can be avoided by determining the pixel skipping pattern by the decision result of the 100% object size.

(Another Embodiment)

FIG. 17 shows a specific example of processing when a subject of the black over print is expanded to the 100% black object having a white component. A (a) of FIG. 17 is the image drawn in the specific example. The image shown in (a) of FIG. 17 is drawn such that the 100% black object having the yellow component is partially overlapped with a yellow area of the background. A (b-1) of FIG. 17 is the drawing area of a yellow plane in the black over print processing whose subject is only the 100% black object, and open processing is performed to the area where the 100% black object is overlapped. A (b-2) of FIG. 17 is the black over print processing whose subject is only the 100% black object, and (b-2) of FIG. 17 shows the print image when the print shift of yellow has occurred toward the left direction.

A (c-1) of FIG. 17 is the drawing area of the yellow plane in the black over print processing whose subject is the 100% black object having a color component, and (c-2) of FIG. 17 shows the print image when the print shift of yellow has occurred toward the left direction. According to the pixel skipping processing of the invention, as shown in (c-2) of FIG. 17, in the black over print whose subject is the 100% black object having the color component, even if the 100% black object in which the back ground is not drawn comes into contact with the other objects, the high-quality image formation can be performed without generating the white patch on the printed image.

Those skilled in the art can realize the invention by the above-described various embodiments. Further, various modifications of the embodiments can be made by those skilled in the art, and the invention can be applied to various embodiments without any inventive ability. Therefore, the invention covers the broader range consistent to the disclosed principle and the novel feature, and the invention is not limited to the above-described embodiments.

1. A printer apparatus which forms an image on the basis of given PDL information, comprising:
a generating unit which generates background image information and black image information drawn by black pixels from the PDL information;
an erasing unit which erases a part of image information superimposed on an area of the black image information from the background image information generated by the generating unit in accordance with a particular pattern; and
a forming unit which forms an image on a recording medium on the basis of the background image information and the black image information, which are partially erased.

2. A printer apparatus according to claim 1, wherein the erasing unit erases a part of image information superimposed on the area of the black image information from the background image information in accordance with a pattern in which a line to be erased and a non-erasure line are reiterated by the line in a main scanning direction perpendicular to a feed direction of the recording medium.

3. A printer apparatus according to claim 1, wherein the erasing unit erases a part of image information superimposed on the area of the black image information from the background image information in accordance with the pattern in which the line to be erased and the non-erasure line are reiterated by the line in a sub-scanning direction parallel to the feed direction of the recording medium.

4. A printer apparatus according to claim 1, wherein the erasing unit erases the image information shown by the particular pattern obtained by computation in the image information superimposed on the area of the black image information from the background image information.

5. A printer apparatus according to claim 1, wherein the erasing unit detects a type of the image recording medium, determines the pattern which erases a part of image information superimposed on the area of the black image information from the background image information in accordance with the type of the recording medium, and performs the erasure in accordance with the pattern.

6. A printer apparatus according to claim 1, wherein the erasing unit detects half tone information of the background image information, determines the pattern which erases a part of image information superimposed on the area of the black image information from the background image information in accordance with the type of half tone, and performs the erasure in accordance with the pattern.

7. A printer apparatus according to claim 1, wherein the erasing unit detects a type of color transformation table for use in the image formation, determines the pattern which erases a part of image information superimposed on the area of the black image information from the background image information in accordance with the type of color transformation table, and performs the erasure in accordance with the pattern.

8. A printer apparatus according to claim 1, wherein the erasing unit determines the pattern which erases a part of image information superimposed on the area of the black image information from the background image information on the basis of an absolute coordinate of the image to be drawn and performs the erasure in accordance with the pattern.

9. A printer apparatus according to claim 1, wherein the erasing unit detects a printing direction on the recording medium, determines the pattern which erases a part of image information superimposed on the area of the black image information from the background image information on the basis of the printing direction, and performs the erasure in accordance with the pattern.

10. A program which is installed in a control unit of a printer apparatus which forms an image on the basis of given PDL information to perform the following process, the program comprising the processes of:
generating background image information and black image information drawn by black pixels from the PDL information;
erasing a part of image information superimposed on an area of the black image information from the background image information generated by the generating unit; and
forming the image on a recording medium on the basis of the background image information and the black image information, which are partially erased.

11. A program according to claim 10, wherein the erasing process erases a part of image information superimposed on the area of the black image information from the background image information in accordance with a pattern in which a line to be erased and a non-erasure line are reiterated by the line in a main scanning direction perpendicular to a feed direction of the recording medium.

12. A program according to claim 10, wherein the erasing process detects a type of the image recording medium, determines the pattern which erases a part of image information superimposed on the area of the black image information from the background image information in accordance with the type of the recording medium, and performs the erasure in accordance with the pattern.

13. A program according to claim 10, wherein the erasing process detects half tone information of the background image information, determines the pattern which erases a part of image information superimposed on the area of the black image information from the background image information in accordance with the type of half tone, and performs the erasure in accordance with the pattern.

14. A program according to claim 10, wherein the erasing process detects a type of color transformation table for use in the image formation, determines the pattern which erases a part of image information superimposed on the area of the black image information from the background image information in accordance with the type of color transformation table, and performs the erasure in accordance with the pattern.

15. A program according to claim 10, wherein the erasing process determines the pattern which erases a part of image information superimposed on the area of the black image information from the background image information on the basis of an absolute coordinate of the image to be drawn and performs the erasure in accordance with the pattern.

16. An image forming apparatus which forms an image on the basis of given PDL information, comprising:
a generating unit which generates background image information and black image information drawn by black pixels from the PDL information;
an erasing unit which erases a part of image information superimposed on an area of the black image information from the background image information generated by the generating unit; and
a forming unit which forms an image on a recording medium on the basis of the background image information and the black image information, which are partially erased.

17. An image forming apparatus according to claim 16, wherein the erasing unit detects a type of the image recording medium, determines the pattern which erases a part of image information superimposed on the area of the black image information from the background image information in accordance with the type of the recording medium, and performs the erasure in accordance with the pattern.

18. An image forming apparatus according to claim 16, wherein the erasing unit detects half tone information of the background image information, determines the pattern which erases a part of image information superimposed on the area of the black image information from the background image information in accordance with the type of half tone, and performs the erasure in accordance with the pattern.

19. An image forming apparatus according to claim 16, wherein the erasing unit detects a type of color transformation table for use in the image formation, determines the pattern which erases a part of image information superimposed on the area of the black image information from the background image information in accordance with the type of color transformation table, and performs the erasure in accordance with the pattern.

20. An image forming apparatus according to claim 16, wherein the erasing unit determines the pattern which erases a part of image information superimposed on the area of the black image information from the background image information on the basis of an absolute coordinate of the image to be drawn and performs the erasure in accordance with the pattern.
